(19) United States
(12) Patent Application Publication
(10) Pub. No.: US 2008/0208887 A1
(43) Pub. Date: Aug. 28, 2008

(54) Method, apparatus, and program product for creating and maintaining a data model

(76) Inventors: Girish K. Balachandran, Mountain View, CA (US); Todd A. Fast, San Francisco, CA (US); Ayub S. Khan, Cupertino, CA (US); Samaresh Panda, Fremont, CA (US); Christopher Webster, Dublin, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(21) Appl. No.: 11/711,303

(22) Filed: Feb. 27, 2007

(51) Int. Cl. G06F 17/00

(52) U.S. Cl. 707/102; 707/E17.055

(57) ABSTRACT

Apparatus, methods, and computer program products are disclosed that teach a method of generating a concrete-schema-instance as a result of modifying a representation of an abstract-instance-object-model. The concrete-schema-instance so generated represents an information-model used to process a concrete-information-instance.

### BACKGROUND

1. Technical Field

The disclosed technology relates to the field of information interface tools (for example, tools that use, create, and/or manipulate XML, SGML, or other information markup instances and/or schemas).

2. Background Art

Prior to development of generalized data description languages programmers would define custom file data formats or simple data languages to share information between programs. This required the programmer to create (at a very low level of abstraction) detailed specifications and code for the required custom data parser and writer routines to create and use the data that carried the information between the programs.

With a markup language such as the “Standard Generalized Markup Language” (SGML) or the “Extensible Markup Language” (XML), etc., the programmer (at a relatively high level of abstraction) can develop rules for such data so that standardized parsing routines/programs/procedures can be used to create, read and use the data carrying the information.

SGML and XML provide a text-based mechanism that describes a tree-based structure for the information carried by the data in the SGML/XML text. The information can be expressed as self-structured textual data in that the data itself includes elements (for example, markup elements) used to define the structure of the information carried by the data. The structure includes a hierarchy of container-like elements for holding the information as well as attributes about the container-like elements.

In the XML environment, a structured information instance (such as a data file, data-stream or other concrete-information-instance) is “well-formed” if it conforms to a markup language's syntax rules. In addition, the structured information instance is “valid” if the data and the information structure conform to an information-model (such as a concrete-schema-instance defined using a schema language). The information-model constrains the structure and/or content of the data contained in the structured information instance. These constraints can include restrictions on element and attribute names (and their allowable containment hierarchies) as well as restrictions or requirements on an element's data-type. Thus, the information-model is a high-level abstraction of what information can be included in a well-formed and valid structured information instance. Schema languages exist to define schemas or other information-models. A structured information instance is associated with its information-model in accordance with the requirements of the schema language used to define the schema. Examples of such schema languages include the simple Document-Type-Definition (DTD) schema language, and vastly more complex and capable languages such as the W3C® XML schema language (WXS) and the RELAX_NG schema language.

As previously discussed, a concrete-information-instance can be validated against an information-model. The information-model is commonly defined using some schema language (such as the W3C XML schema language) and defines both the structure and data types for the information carried by the structured information instance. In some sense, the schema language is similar to a programming language for the information carried by the data in a structured information instance.

XML is one example of a structured information instance validated by an information-model. An XML data instance (an example of a concrete-information-instance) is a fairly simple, human-readable, self-structured, textual document. The XML data instance is self-structured in that the XML data instance identifies attributes, comments, and textual data, and provides structure for the information carried by the XML data instance. The XML data instance carries information in accordance with its validating information-model (for example, one defined using the W3C XML schema language). Thus for example, while an XML data instance can carry information to be presented in tabular form, the information-model defines that a table exists and that the table contains information of a specified type.

One skilled in the art will understand that information within a structured information instance (such as an XML data instance) is much simpler than the definition of the corresponding information-model (such as one written using the W3C XML schema language).

The information-models (schemas) share some characteristics with relational databases in that they can and should be normalized for computational efficiency purposes. However such normalized information-models (like normalized databases) are often difficult to understand and use because the normalized information-model structure spreads the information-model across multiple files/tables. This makes it difficult and unwieldy for a non-expert to use, edit, or create an information-model. The difficulty of understanding the schema language and of creating a computationally efficient information-model is a barrier that inhibits the programmer from using a fully-featured, complex markup language such as the W3C XML schema language.

While there exist prior art programs/tools to assist with creating information-models these programs/tools require the programmer to be familiar with the schema language used to create the information-model. These programs/tools provide little more than a graphical representation of the schema language. The programmer must still develop and maintain a detailed understanding of the schema language used to define an information-model when creating or modifying the information-model. Furthermore, the creation of an information-model requires significant programmer effort and time even if the programmer uses the available programs/tools.

It would be advantageous to provide a technology that simplifies the creation of an information-model for programmers who are not experts in any particular schema language.

### BRIEF DESCRIPTION OF THE DRAWINGS

FIG. 1 illustrates a computer system that can be used to embody the disclosed technology;

FIG. 2 illustrates information-model concepts;

FIG. 3 illustrates an example GUI that can be used to present and allow manipulation of an abstract-data-representation by a programmer;

FIG. 4 illustrates a schema editing process;

FIG. 5 illustrates a abstract-instance-object-model creation process from a schema language; and

FIG. 6 illustrates a synchronization process used to keep the abstract-instance-object-model in synchronization.

### DETAILED DESCRIPTION

One aspect of the technology disclosed within is a method of generating a concrete-schema-instance as a result of modifying a representation of an abstract-instance-object-model. The concrete-schema-instance so generated represents an information-model used to process a concrete-information-instance. Other aspects of the technology include apparatus that perform the method and program products that, when executed by a computer, cause the computer to perform the method.

The inventors have determined that programmers who are not expert in a schema language can easily understand a structured information instance. The technology disclosed herein enables a programmer to manipulate an abstract-data-representation to create a concrete-schema-instance that will validate a concrete-information-instance of the form indicated by the abstract-data-representation that represents the structured information instance. Thus, a programmer can operate at the level of abstraction of, for example, an XML data instance when creating a validating concrete-schema-instance for that XML data instance. In other words, the disclosed technology allows the programmer to visualize an information-model using an abstract-data-representation as a metaphor for the information-model. The technology gives the programmer the ability to declaratively construct the abstract-data-representation and to automatically create a validating information-model for concrete-information-instance represented by the abstract-data-representation. For example, a programmer who is not an XML expert, but using tools that implement the disclosed technology, can easily create an information-model that will validate a concrete-information-instance that has the characteristics of the abstract-data-representation defined by the programmer. The information-model can be instantiated as a concrete-schema-instance defined using a schema language such as the W3C XML schema language. Thus for example, a programmer who needs to pass XML formatted information can focus on the information that will be contained in a concrete-information-instance instead being distracted by the complex and tortuous details of the schema language used to define a validating XML schema for the information. By using tools built on the disclosed technology, both expert and non-expert programmers become more efficient at generating information-models for concrete-information-instances.

The abstract-data-representation is a representation of an abstract-instance-object-model. As a programmer manipulates the abstract-data-representation the technology disclosed herein changes the abstract-instance-object-model accordingly and thus modifies the information-model. A programmer can manipulate the abstract-data-representation using any editor tool. One embodiment uses a graphical user interface (GUI) designed to represent the elements, attributes, element hierarchy and data in an XML data instance. Some embodiments of the editor tool generate files that can be compiled into an information-model. Other embodiments dynamically and/or interactively generate the information-model. An existing information-model can be read by some of these tools to generate a corresponding abstract-data-representation (such as a text file) for subsequent manipulation. The technology disclosed herein is generally implemented as a computer program for execution by a computer and some embodiments use the JAVA® programming system. However, the technology can also be totally or partially implemented on custom electronics.

The disclosed technology teaches how to create a normalized information-model by creating and/or modifying an abstract-data-representation (for example, creating an information-model using an Author-By-Example approach); how to transform an information-model (normalized or not) to an abstract-data-representation for subsequent review or modification; how to transform an abstract-data-representation into an information-model (such as a structured information instance or normalized structured information instance; and how to provide code completion capability when manipulating concrete-information-instances and/or abstract-data-representations.

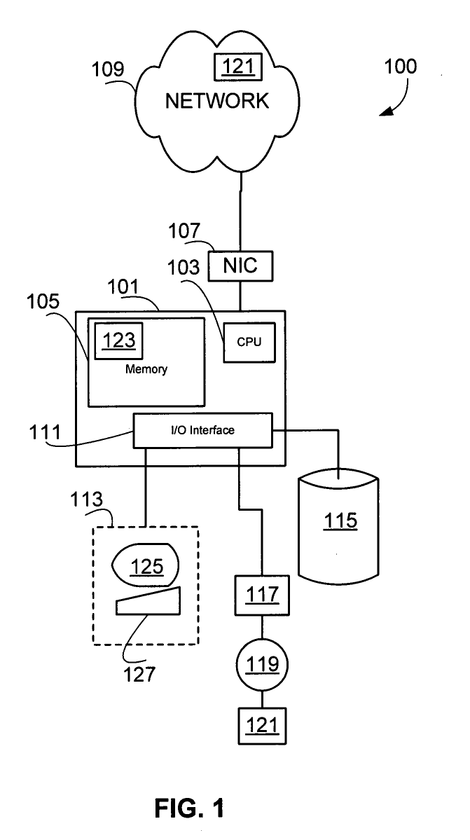

FIG. 1 illustrates a computer system 100 that can incorporate an embodiment of the technology disclosed herein. The computer system 100 includes a computer 101 that incorporates a CPU 103, a memory 105, and optionally a network interface 107. The network interface 107 can provide the computer 101 with access to a network 109. The computer 101 also includes an I/O interface 111 that can be connected to a user interface device(s) 113, a storage system 115, and a removable data device 117. The removable data device 117 can read a computer-usable data carrier 119 (such as a fixed or replaceable ROM within the removable data device 117 itself (not shown); as well as a computer-usable data carrier that can be inserted into the removable data device 117 itself (such as a memory stick, CD, floppy, DVD or any other tangible media) that typically contains a program product 121. The user interface device(s) 113 can include a display device 125 and a user input device 127. The storage system 115 (along with the removable data device 117), the computer-usable data carrier 119, and (in some cases the network 109) comprise a file storage mechanism. The program product 121 on the computer-usable data carrier 119 is generally read into the memory 105 as a program 123 which instructs the CPU 103 to perform specified operations. In addition, the program product 121 can be provided from devices accessed using the network 109. One skilled in the art will understand that the network propagates information (such as data that defines a computer program). Generally, the information is embodied within a carrier-wave. The term “carrier-wave” includes electromagnetic signals, visible or invisible light pulses, signals on a data bus, or signals transmitted over any wire, wireless, or optical fiber technology that allows information to be propagated from one point to another. Programs and data are commonly read from both tangible physical media (such as those listed above) and from the network 109. Thus, the network 109, like a tangible physical media, is a computer-usable data carrier. One skilled in the art will understand that not all of the displayed features of the computer 101 need to be present for all embodiments that implement the techniques disclosed herein.

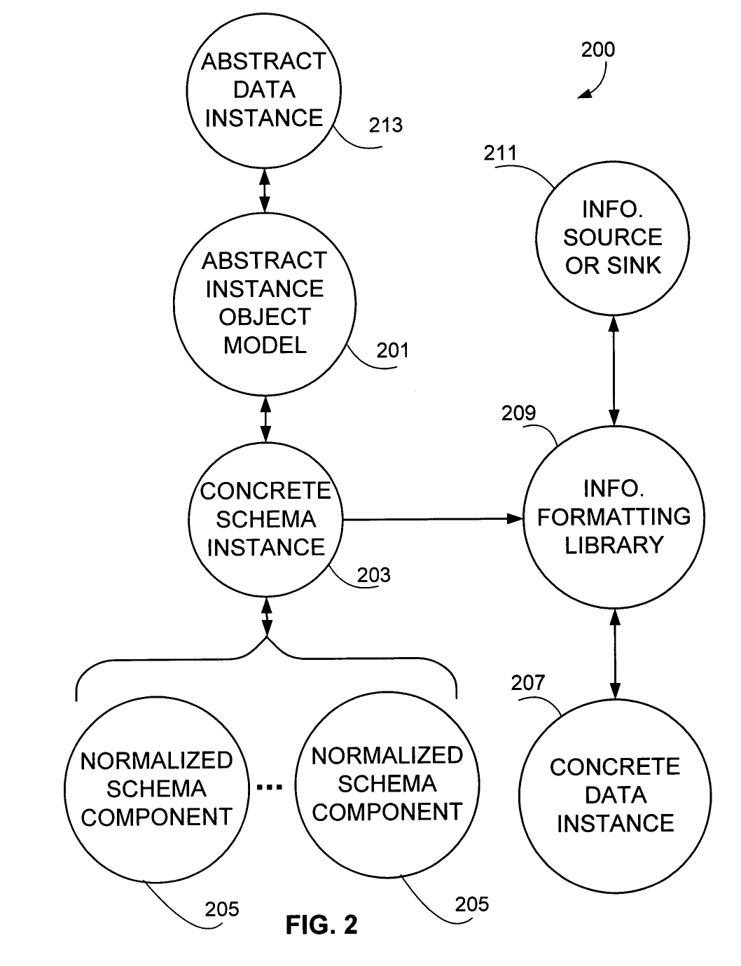

FIG. 2 illustrates a conceptual information-model overview 200. A programmer designs an information-model that is embodied by an abstract-instance-object-model 201. The abstract-instance-object-model 201 models a set of data types and instances of those types and can generate a schema instance 203 defined using some schema language (for example the W3C XML schema language). Some schema instances can be normalized where, similar to relational databases, the schema instance 203 is separated for computational efficiency such that the schema instance 203 comprises a number of normalized schema portions such as a normalized schema portion 205. A concrete-data-instance 207 (such as an XML data instance) can be processed (for example, created, accessed, or validated) with respect to the information-model using, for example, an information formatting library 209 that accesses the schema instance 203 (or normalized concrete-schema-instance) and supports an information source/sink 211.

The technology disclosed within uses an abstract data instance 213 as a tool to allow a programmer (or other user) to develop the abstract-instance-object-model 201 without the need to understand the details of the schema language used to create the schema instance 203. Using the abstract data instance 213 the programmer is able to design an information-model (that is embodied in the abstract-instance-object-model 201) using a data instance metaphor (for example, the abstract data instance 213 can be presented in a form that is very similar to an XML instance document). Thus, both the abstract data instance 213 and the schema instance 203 represent the information-model. The abstract data instance 213 allows the programmer to visualize the possible instance documents from the abstract-data-representation for a given information-model (schema). As the programmer changes the abstract-data-representation, the information-model is changed accordingly. The abstract-instance-object-model 201 can transform the information-model between the abstract data instance 213 and the schema instance 203 and can generate either. Thus, the information-model can be initialized using an existing schema such as the schema instance 203 as well as created or modified by manipulation of the abstract data instance 213.

Because the abstract data instance 213 and the abstract-instance-object-model 201 are synchronized, the disclosed technology can assist the programmer when creating or modifying the information-model. For example, when the programmer uses a GUI to manipulate the abstract data instance 213 the GUI can, after the programmer's selection of a portion of the abstract data instance 213 and/or on receiving a partial input from the programmer, closely interact with the information-model to provide options to the programmer based on the programmer's position in the information-model. For example, as a programmer starts to provide input to the GUI, the GUI can communicate with the information-model to offer possible completions for the programmer's partial input (for example, code-completion). For another example, instant contextual help messages can also be provided to the programmer to explain or further describe one or more of the possible completions.

Because the complete information-model is maintained by the abstract-instance-object-model 201 the programmer is not exposed to any normalization aspect of the schema instance 203 and need not consider details related to the normalized schema portion 205. The transformation back and forth between the schema instance 203 (normalized or not) and the abstract data instance 213 is automatically performed by the abstract-instance-object-model 201.

Because the abstract-instance-object-model 201 represents the information-model, the abstract-instance-object-model 201 can also be used to transform one schema instance (for example, one concrete-schema-instance (defined using a first schema language) into an equivalent concrete-schema-instance (defined using a second schema language). In addition, because the non-expert programmer modifies the schemas using through the abstract-instance-object-model 201, the programmer need not become an expert in both the first and second schema languages.

One skilled in the art will understand that the information formatting library 209 can be included within the information source/sink 211.

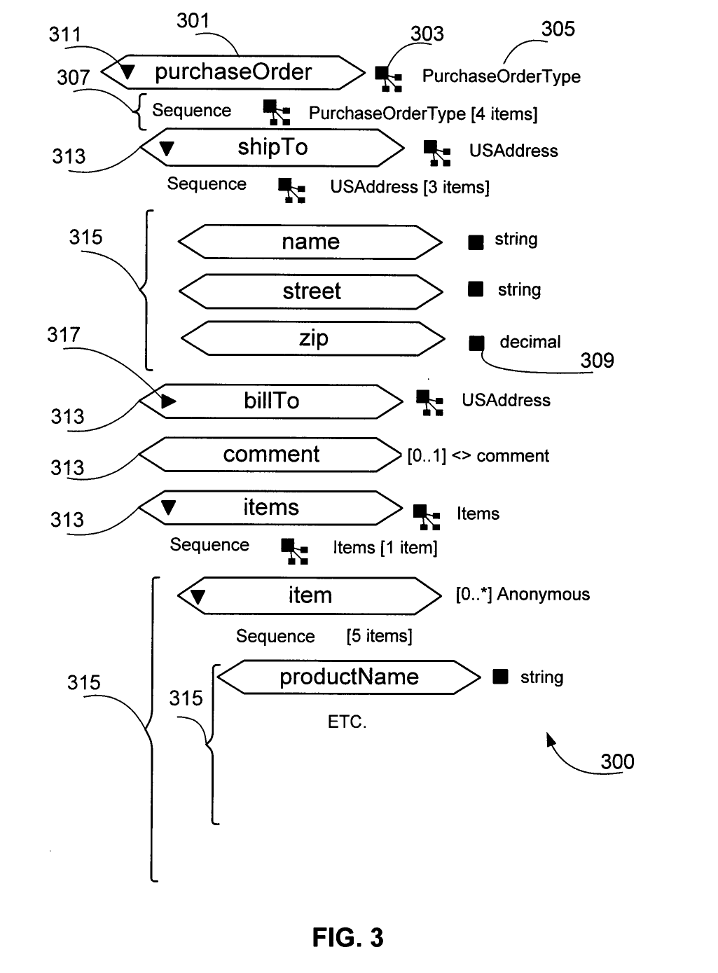

FIG. 3 illustrates an abstract-data-representation representation 300 that can be presented to and manipulated by a programmer using a Graphical User Interface. An element representation 301 includes the name of the element (here “purchaseOrder”). The element representation 301 indicates that it is a complex element that contains other elements. The complex nature of the element representation 301 is shown by a compositor type classification indicator 303. The type of the element representation 301 is presented by an element type identification 305. When the element representation 301 is expanded, the GUI can also present expanded-element-detail information 307 that presents information about what the expanded element contains. Some elements are not made up of combinations of other elements or attributes. Such elements can be indicated by a simple element type classification indicator 309 (for example, as shown for decimal or string element types). Expansion of an element is controlled by a user-activated-control such as an activated element expansion control 311 (shown in the activated state). Because the element representation 301 is in its expanded mode (indicated here by the activated element expansion control 311 pointing down), the four elements that directly make up the element representation 301 are presented (as indicated as a top-level expanded element 313—all four elements are given the same label in FIG. 3). Similarly, a lower-level expanded element 315 can present the elements contained in the top-level expanded element 313. A complex element that is not expanded (for example the “bill-to” element) can be indicated by an inactivated element expansion control 317 different from the activated element expansion control 311 (in this example, the inactivated element expansion control 317 points to the right while the activated element expansion control 311 points down). The element representations can also present the element's attributes. One skilled in the art will understand that there need not be any distinction between the top- and lower-level elements. The distinction made in this paragraph was to simply the description of FIG. 3.

Such Author-By-Example tools allow programmers to interactively build an information-model that can be used to generate a concrete-schema-instance. Thus, users with little or no prior knowledge of the W3C XML schema language (or other schema language) can create an XML schema and generate a code/object library that will produce a concrete-information-instance that will be validated by that XML schema.

The disclosed technology seamlessly automates the propagation of structural or type changes throughout the information-model. For example, if the programmer adds an element to the USAddress in the shipTo field, the USAddress in the billTo field will change accordingly.

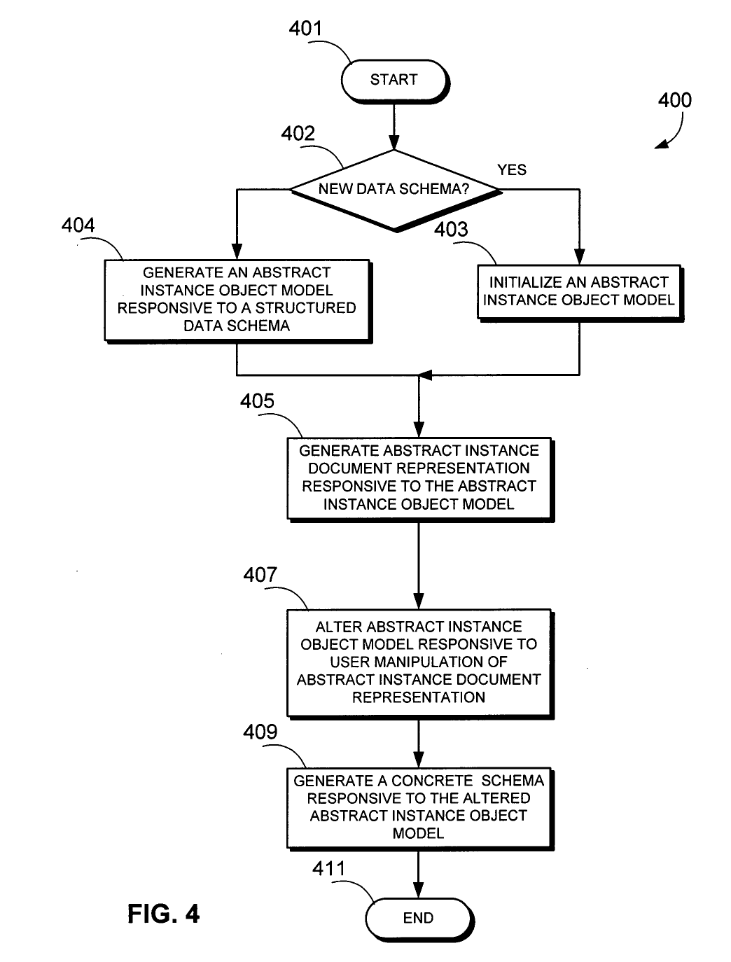

FIG. 4 illustrates a schema editing process 400 that can be initiated at a start terminal 401 resulting from an invocation from a user/programmer of a Schema editor (such as Sun Microsystems, Inc.'s Author-By-Example, a schema authoring capability in NetBeans Enterprise Pack 5.5). The schema editing process 400 continues to a ‘new/open’ decision procedure 402 that determines whether an existing or new information-model is to be edited/created. If a new information-model is to be created, the schema editing process 400 continues to an ‘initialize abstract-instance-object-model’ 403 that initializes an abstract-instance-object-model representing an initialized information-model. If an existing information-model is to be accessed, the schema editing process 400 at the ‘new/open’ decision procedure 402 continues to a ‘generate abstract-instance-object-model’ procedure 404 that accesses a concrete-schema-instance to generate the abstract-instance-object-model corresponding to the concrete-schema-instance of the existing information-model. Once the abstract-instance-object-model is created, the schema editing process 400 continues to a ‘generate abstract instance document’ procedure 405 that generates an abstract-data-representation of the information-model for presentation to the programmer. The schema editing process 400 then continues to an ‘alter abstract instance object model’ procedure 407 that allows the programmer to manipulate the abstract-data-representation to add/remove/modify structure, elements, and attributes and thus to design the characteristics common to any concrete-information-instance that will be able to be validated by the information-model resulting from the schema editing process 400. When the programmer has completed manipulation of the abstract-data-representation, the schema editing process 400 continues to a ‘generate concrete schema’ procedure 409 that generates a concrete-schema-instance for the information-model that will validate any concrete-information-instance that has the structure, elements and attributes of the abstract-data-representation. When the concrete-schema-instance is completed, the schema editing process 400 completes through an end terminal 411. Processing the concrete-information-instance includes any creating, validating, accessing, or modifying of the concrete-information-instance in compliance with the information-model.

In some embodiments the functionality of the ‘alter abstract instance object model’ procedure 407 and the ‘generate concrete schema’ procedure 409 are combined such that as the programmer modifies the abstract-data-representation corresponding changes are made not only to the abstract-instance-object-model but to the concrete-schema-instance as well.

The abstract-data-representation can be created and manipulated using a GUI, a text editor, etc. The abstract-data-representation is similar to a minimal concrete-information-instance including all structure, elements, and attributes but need not contain data that would be included in a concrete-information-instance. An example of a GUI presentation of an abstract-data-representation was shown on FIG. 3. As the abstract data instance 213 is manipulated, the manipulations are synchronized with the abstract-instance-object-model 201 and the schema instance 203.

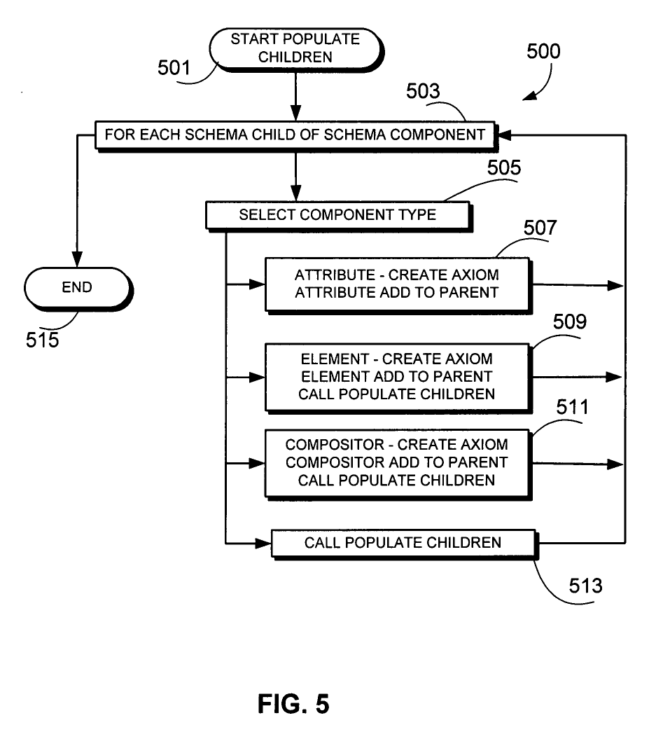

The abstract-instance-object-model 201 maintains a tree-like model structure having a root that is a document component. A recursive procedure (such as shown in FIG. 5 can be used to create the model structure for the abstract-instance-object-model 201.

FIG. 5 illustrates an abstract-instance-object-model creation process 500 that can be recursively invoked (as subsequently described), as well as invoked from any information-model creation process such as is described with respect to FIG. 4 (in particular by the ‘initialize abstract-instance-object-model’ 403 and the ‘generate abstract-instance-object-model’ procedure 404). The abstract-instance-object-model creation process 500 also de-normalizes a normalized schema instance 203 to “flatten” the schema instance 203. The abstract-instance-object-model 201 is thus free of normalization artifacts (such as data types and other forms of substitution and reuse). The abstract-instance-object-model 201 retains information otherwise specifying the content model (for example, minOccurs/maxOccurs).

For example, where the schema instance 203 is defined using the W3C XML schema language, the abstract-instance-object-model 201 represents all the defined elements, attributes and (if used) compositors for each element at all times. The denormalization can occur as a single computation using the entire XML schema or can be computed for each element as it is expanded in the abstract data instance 213. Both approaches are equivalent.

That is, if the schema is not manipulated or changed, the abstract-instance-object-model 201 does not change. Because the abstract-instance-object-model 201 maintains a denormalized representation of the information-model, manipulations of the abstract data instance 213 are effectively refactorings and thus, these changes are processed in a manner similar to refactorings related to instance documents conforming to the information-model.

The abstract-instance-object-model creation process 500 initiates at a start populate-children terminal 501 with one parameter being a parent object from the abstract-instance-object-model and another being a parent schema object. The abstract-instance-object-model creation process 500 continues to a ‘for each schema child’ iterative procedure 503 that processes each child of the provided parent schema object. As each schema child is iterated, the child's component type is determined by a ‘select component type’ procedure 505 to be an attribute, element, compositor, or other schema object and the appropriate handler is selected to process the schema child object. These handlers can include an ‘attribute handler’ procedure 507, an ‘element handler’ procedure 509, a ‘compositor handler’ procedure 511, a ‘default handler’ procedure 513 and etc. After the schema child objects of the passed schema parent are processed, the abstract-instance-object-model creation process 500 returns through an ‘end’ terminal 515.

The ‘attribute handler’ procedure 507 instantiates an attribute object in the abstract-instance-object-model with attributes equivalent to that of the schema child object and adds that attribute object to the passed abstract-instance-object-model parent object.

The ‘element handler’ procedure 509 instantiates an element object in the abstract-instance-object-model, adds the instantiated object to the passed abstract-instance-object-model parent object, determines the type definition for the element object and recursively invokes the abstract-instance-object-model creation process 500 (by the call to populate children) passing the element object as the abstract-instance-object-model parent object and the type definition as the parent schema object.

The ‘compositor handler’ procedure 511 instantiates a compositor object in the abstract-instance-object-model, adds that object to the passed abstract-instance-object-model parent object and recursively invokes the abstract-instance-object-model creation process 500 (by the call to populate children) passing the instantiated compositor object and forwarding the schema child object.

The ‘default handler’ procedure 513 recursively invokes the abstract-instance-object-model creation process 500 (by the call to populate children) forwarding both the passed abstract-instance-object-model parent object and the schema child object.

After each handler completes, the abstract-instance-object-model creation process 500 continues back to the ‘for each schema child’ iterative procedure 503 to iterate the next child component of the parent object. When all child components have been iterated, the abstract-instance-object-model creation process 500 terminates its respective recursive invocation by completing through an ‘end’ terminal 515.

One aspect of the information-model is that most complex schema languages (such as the W3C XML schema language) allow “type definition and reuse” such that a programmer can define a data type and then use that defined data type elsewhere in the same schema and/or across other schemas. This capability requires that objects that use those data types monitor when the data type is changed (for example, as a result of a manipulation of the abstract data instance 213) so that the data type definitions remain synchronized across uses. An example of this was previously discussed with respect to FIG. 3 with regards to the change of USAddress. Furthermore, most complex schema languages (such as the W3C XML schema language) include the capability to include and/or import other schema components.

In some embodiments a local proxy object monitors the definition of a type and detects changes such that the changes are propagated throughout the information-model. Thus, if a change is made to an information-model all applications that use that information-model are informed of the change and adjust accordingly. For imported schema components, a remote proxy monitors the schema referencing model for changes and responds accordingly.

Information-models can be represented in multiple ways (for example, as a tree, a table, as text, or as an abstract-data-representation). Each way can be presented as a different view into the information-model. Changes made to the information-model while in one view need to be synchronized with the other views of the information-model. In addition, changes made by one programmer need to be synchronized with changes made by another.

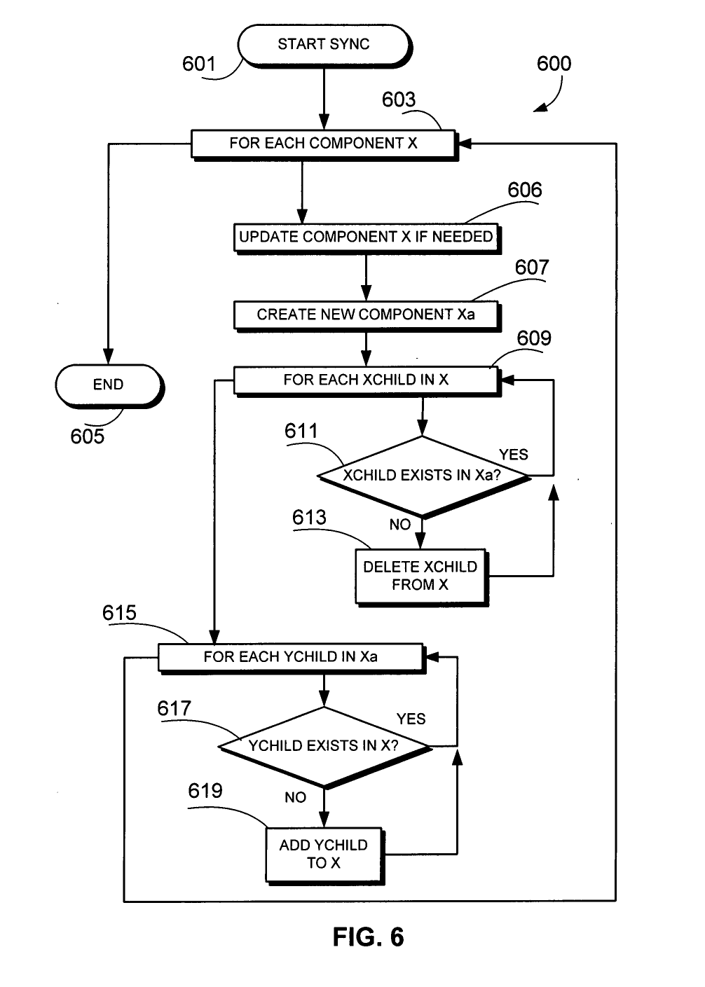

FIG. 6 illustrates a synchronization process 600 that synchronizes the information-model to changes in other views. When a change to the information-model is made in one view, the information-model self synchronizes the other views to the change. Once a change in the information-model is detected, the synchronization process 600 is invoked, initiates at a start terminal 601 and continues to a ‘component X’ iterative procedure 603 that iterates each component “X” of the existing information-model. After all the components are iterated, the synchronization process 600 completes through an ‘end’ terminal 605. As each component X is iterated, an ‘update properties’ procedure 606 determines if the iterated component has properties that need to be updated (whether or not the need is due to the change that was detected) and updates such properties to their current state. Next, a ‘create new component Xa’ procedure 607 constructs a new version Xa corresponding to the iterated X using the information-model defined by the reference version of the concrete-schema-instance (which is the currently “true” definition of the concrete-schema-instance). Then an ‘Xchild’ iterative procedure 609 iterates each child of X. The iterated child of X is checked by an ‘Xchild exists in Xa’ decision procedure 611 to determine whether the iterated child of X exists in the newly created Xa. If the child does not exist in Xa, a ‘delete Xchild’ procedure 613 deletes the iterated child X from its parent component. The synchronization process 600 continues to the ‘Xchild’ iterative procedure 609 to continue processing each child of X.

When all the children of X have been iterated, the synchronization process 600 continues to a ‘Ychild’ iterative procedure 615 that iterates each child (Ychild) in Xa. For each iterated child, a ‘Ychild exists in X’ decision procedure 617 determines whether the iterated Ychild exists in X. If the Ychild does not exist in X, an ‘add Ychild to X’ procedure 619 adds the Ychild to X and the synchronization process 600 continues to the ‘Ychild’ iterative procedure 615 to complete the iteration of the children of Xa. When the ‘Ychild’ iterative procedure 615 completes, the synchronization process 600 continues back to the ‘component X’ iterative procedure 603 to synchronize the next component in X.

From the foregoing, it will be appreciated that the technology has (without limitation) the following advantages:
1) Because the transformation to and from the abstract-data-representation and the concrete-schema-instance is lossless, programmers who are experts in the schema language and programmers who are non-experts in the schema language can collaborate when developing an information-model; each programmer working at his/her own comfortable level of abstraction.
2) A programmer need not become an expert in the schema language to develop and use an information-model.
3) The abstract-instance-object-model provides full round-trip fidelity such that if a revision is made to the concrete-schema-instance, the abstract-instance-object-model dynamically updates the abstract-data-representation (and vice versa).
4) The abstract-data-representation intelligently hides the complexities of the schema language's features while not restricting a programmer from using these features. Thus, while the abstract-data-representation does not require a programmer to be an expert in the schema language it still provides numerous capabilities that can be used by schema language experts.
5) The abstract-data-representation supports multiple schemas, that is, it denormalizes elements and attributes from imported and included schemas as well as supporting information-models written in different schema languages.
6) The abstract-instance-object-model detects and dynamically adjusts to changes in the design of the information-model.
7) The abstract-instance-object-model can provide code-completion capability and/or contextual help for manipulations of the abstract-data-representation or other use of the information-model.

As used herein, a procedure is a self-consistent sequence of steps that can be performed by logic implemented by a programmed computer, specialized electronics or other circuitry or a combination thereof that lead to a desired result. These steps can be defined by one or more computer instructions. These steps can be performed by a computer executing the instructions that define the steps. Further, these steps can be performed by circuitry designed or configured to perform the steps. Thus, the term “procedure” can refer (for example, but without limitation) to a sequence of instructions, a sequence of instructions, organized within a programmed-procedure or programmed-function, a sequence of instructions organized within programmed-processes executing in one or more computers, or a sequence of steps performed by electronic or other circuitry, or any logic. In particular these steps can be performed by one or more of a generator logic, an information-model modification logic, a presentation logic, an information-model creation logic, a schema transformation logic, a schema access logic, a user input logic, an information-model monitor logic, and a presentation logic separately or combined.

One skilled in the art will understand that the network transmits information (such as informational data as well as data that defines a computer program). The information can also be embodied within a carrier-wave. The term “carrier-wave” includes electromagnetic signals, visible or invisible light pulses, signals on a data bus, or signals transmitted over any wire, wireless, or optical fiber technology that allows information to be transmitted over a network. Programs and data are commonly read from both tangible physical media (such as a compact, floppy, or magnetic disk) and from a network. Thus, the network, like a tangible physical media, can be a computer-usable data carrier.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed follows:

1. A computer controlled method comprising:
modifying an abstract-data-representation, said abstract-data-representation a representation of an abstract-instance-object-model;
generating a concrete-schema-instance from said abstract-instance-object-model, said concrete-schema-instance representing an information-model; and
processing a concrete-information-instance in compliance with said information-model.

2. The computer controlled method of claim 1, further comprising creating said abstract-data-representation.

3. The computer controlled method of claim 2, further comprising:
accessing one or more concrete-schema-components;
transforming said one or more concrete-schema-components into said abstract-instance-object-model; and
wherein generating said concrete-schema-instance generates a second set of concrete-schema-components.

4. The computer controlled method of claim 3, wherein said second set of concrete-schema-components is a normalized concrete-schema-instance.

5. The computer controlled method of claim 3, wherein said one or more concrete-schema-components are defined using a first schema language and said second set of concrete-schema-components is defined using a second schema language.

6. The computer controlled method of claim 1, wherein said concrete-schema-instance is expressed using a schema language.

7. The computer controlled method of claim 6, wherein said schema language is the W3C XML schema language.

8. The computer controlled method of claim 1, wherein said concrete-information-instance is an XML data instance.

9. The computer controlled method of claim 1, wherein modifying said abstract-data-representation further comprises:
receiving a partial input related to a selection within said abstract-data-representation;
monitoring said abstract-instance-object-model with respect to said selection; and
presenting one or more possible completions for said partial input responsive to the monitoring and said partial input.

10. The computer controlled method of claim 1, wherein modifying said abstract-data-representation further comprises:
receiving a partial input related to a selection within said abstract-data-representation;
monitoring said abstract-instance-object-model with respect to said selection; and
presenting a contextual help message responsive to the monitoring and said partial input.

11. An apparatus having a central processing unit (CPU) and a memory coupled to said CPU comprising:
an information-model modification logic configured to modify an abstract-data-representation, said abstract-data-representation a representation of an abstract-instance-object-model;
a generator logic configured to generate a concrete-schema-instance from said abstract-instance-object-model responsive to the information-model modification logic, said concrete-schema-instance representing an information-model; and
an application logic configured to process a concrete-information-instance in compliance with said information-model.

12. The apparatus of claim 11, further comprising an information-model creation logic configured to create said abstract-data-representation that can subsequently be modified by the information-model modification logic.

13. The apparatus of claim 12, further comprising:
a schema access logic configured to access one or more concrete-schema-components;
a schema transformation logic configured to transform said one or more concrete-schema-components accessed by the schema access logic into said abstract-instance-object-model; and
wherein the generator logic generates a second set of concrete-schema-components responsive to the schema transformation logic.

14. The apparatus of claim 13, wherein said second set of concrete-schema-components is a normalized concrete-schema-instance.

15. The apparatus of claim 13, wherein said one or more concrete-schema-components are defined using a first schema language and said second set of concrete-schema-components is defined using a second schema language.

16. The apparatus of claim 11, wherein said concrete-schema-instance is expressed using a schema language.

17. The apparatus of claim 11, wherein said concrete-information-instance is an XML data instance.

18. The apparatus of claim 11, wherein the information-model modification logic further comprises:
a user input logic configured to receive a partial input related to a selection within said abstract-data-representation;
an information-model monitor logic configured to monitor said abstract-instance-object-model with respect to said selection and the user input logic; and
a presentation logic configured to present one or more possible completions for said partial input responsive to the information-model monitor logic.

19. The apparatus of claim 11, wherein the information-model modification logic further comprises:
a user input logic configured to receive a partial input related to a selection within said abstract-data-representation;
an information-model monitor logic configured to monitor said abstract-instance-object-model with respect to said selection and the user input logic; and
a presentation logic configured to present a contextual help message responsive to the information-model monitor logic.

20. A computer program product comprising:
a computer-usable data carrier providing instructions that, when executed by a computer, cause said computer to perform a method comprising:
modifying an abstract-data-representation, said abstract-data-representation a representation of an abstract-instance-object-model;
generating a concrete-schema-instance from said abstract-instance-object-model, said concrete-schema-instance representing an information-model; and
processing a concrete-information-instance in compliance with said information-model.

21. The computer program product of claim 20, further comprising creating said abstract-data-representation.

22. The computer program product of claim 21, further comprising:
accessing one or more concrete-schema-components; and
transforming said one or more concrete-schema-components into said abstract-instance-object-model; and
wherein generating said concrete-schema-instance generates a second set of concrete-schema-components.

23. The computer program product of claim 20, wherein said concrete-schema-instance is expressed using a schema language.

24. The computer program product of claim 23, wherein said schema language is the W3C XML schema language.

25. The computer program product of claim 20, wherein modifying said abstract-data-representation further comprises:
receiving a partial input related to a selection within said abstract-data-representation;
monitoring said abstract-instance-object-model with respect to said selection; and
presenting one or more possible completions for said partial input responsive to the monitoring and said partial input.
